(19) United States
(12) Patent Application Publication
(10) Pub. No.: US 2009/0087007 A1
(43) Pub. Date: Apr. 2, 2009

(54) BELLY POUCH SPEAKER SYSTEM

(76) Inventors: Julia Galanga Paris, Yelm, WA (US); Joshua N. Winsor, Yelm, WA (US)

Correspondence Address: JULIA G. PARIS, PO Box 2590, YELM, WA, 98597, US

(21) Appl. No.: 12/242,318

(22) Filed: Sep. 30, 2008

Related U.S. Application Data
(60) Provisional application No. 60/997,206, filed on Oct. 1, 2007.

(51) Int. Cl. H04R 1/02

(52) U.S. Cl. 381/333

(57) ABSTRACT

The present invention provides a belly pouch speaker system for delivering music to a pregnant belly for facilitating prenatal development. The system generally includes a pouch having a pair of speaker compartments, each having a corresponding speaker positioned therein. The pouch further includes a central compartment, disposed between the speaker compartments, for maintaining a music player therein and coupled to the speakers by audio speaker lines. A fastener cooperates with the pouch and is disposed such that the pouch may be maintained about the belly of the user by selectively adjusting the the fastener.

### CROSS REFERENCE TO RELATED APPLICATIONS

The present application claims priority to the application entitled BELLY POUCH SPEAKER SYSTEM filed on Oct. 1, 2008 as U.S. Provisional Patent Appln. No. 60/997,206 which is fully incorporated herein by reference in its entirety.

### BACKGROUND

The present invention relates generally to the field of portable music and speaker systems. More specifically, the present invention relates to a speaker system configured to be selectively worn on a belly of a user, particularly for delivering music to a fetus during pregnancy.

It has long been proposed that the effects of music, especially certain types of music, are beneficial to the biomedical, behavioral and intellectual performance of the human mind. Additionally, much evidence exists linking the development of a child to the prenatal environment to which the child was exposed. As such, it may be advantageous to provide a system for the delivery of music to a fetus in order to facilitate development thereof.

It is, therefore, an objective of the present invention to provide such a system.

It is another objective of the present invention to provide a system for the delivery of music for therapeutic benefit of the mother.

### BRIEF DESCRIPTION OF THE DRAWINGS

FIG. 1 is a top plan view of a belly pouch speaker system in accordance with the present invention

FIG. 2 is a detailed top view of a ribbon fastening mechanism of the present invention.

FIG. 3 is a detailed schematic view of the components and inner compartments of the pouch of the peasant invention.

FIG. 4 is a music player and audio speaker line in accordance with the present invention.

FIGS. 5-7 show a padding portion for use with the pouch of the present invention.

FIG. 8 is a perspective view of the present invention being worn by a user.

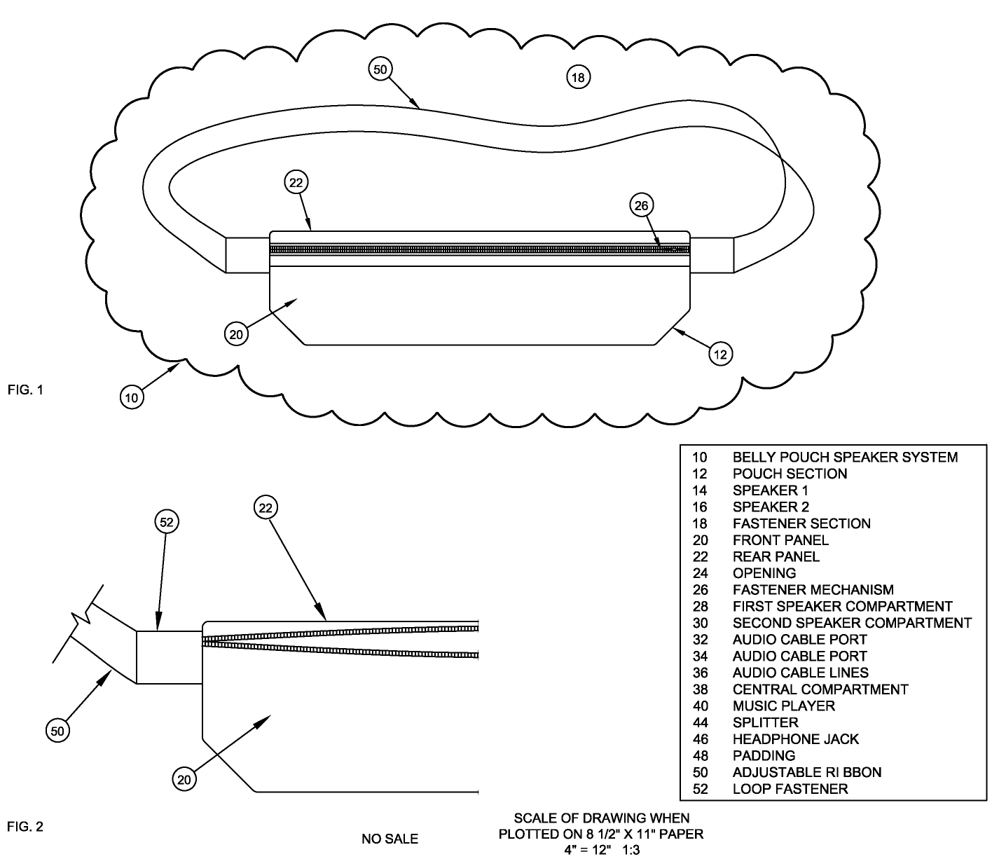

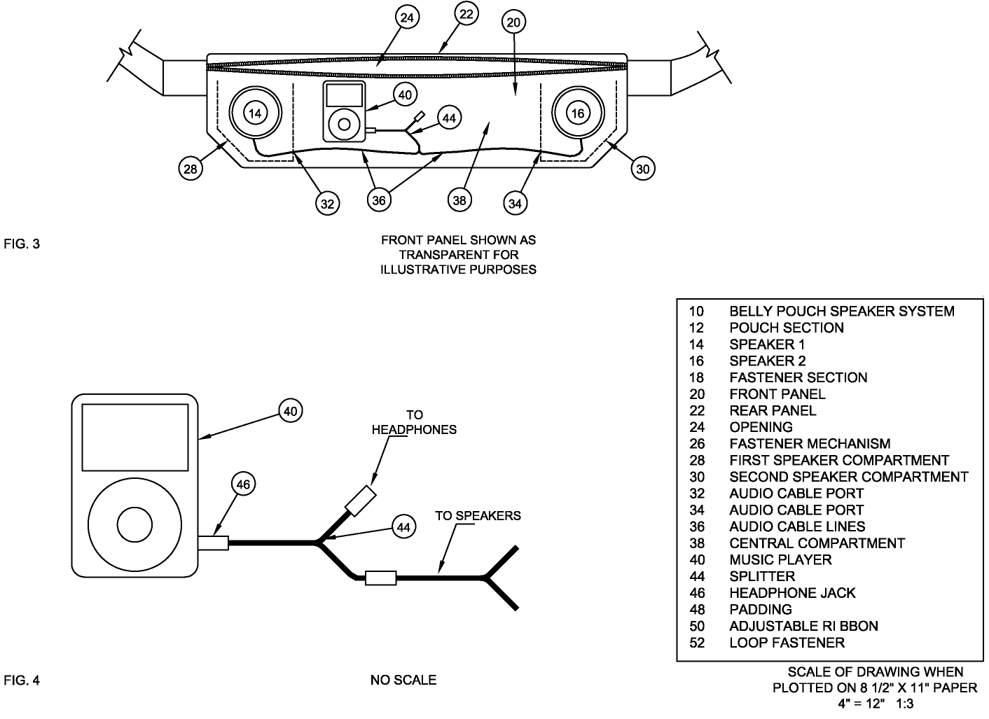

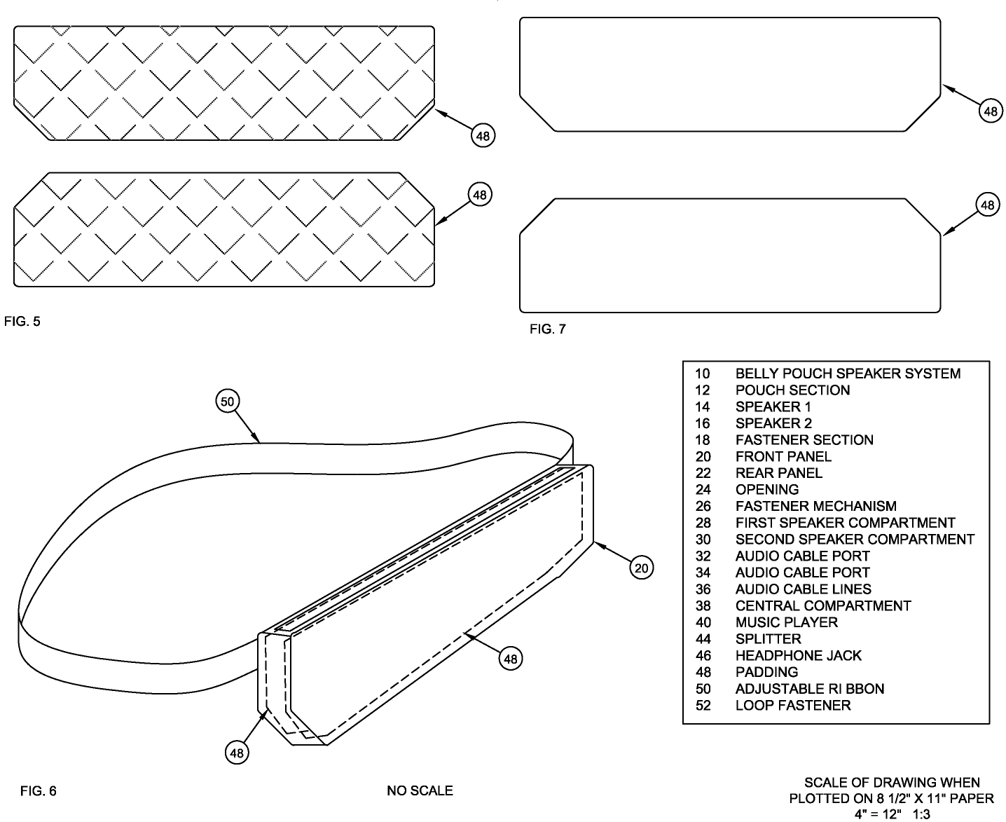

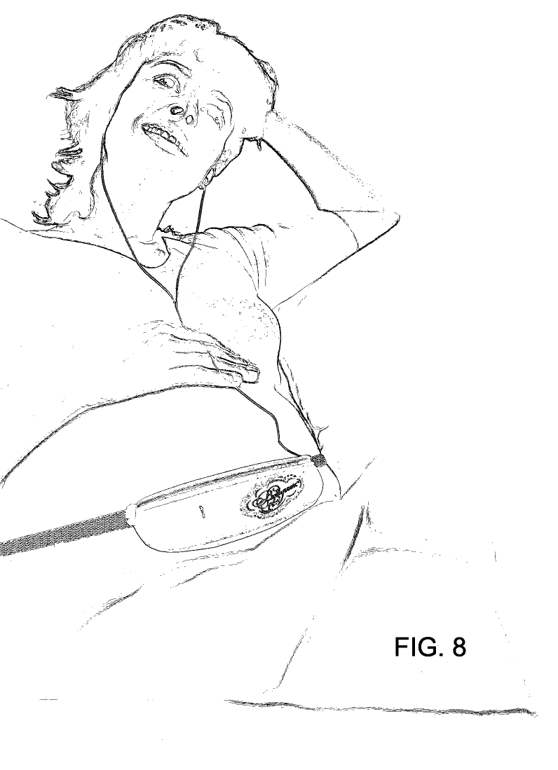

### DETAILED DESCRIPTION

Referring now to the drawings, wherein like reference numerals designate identical or corresponding parts throughout the several views, the figures illustrate a preferred embodiment of a belly pouch speaker system 10, hereinafter referred to as a the system 10.

The system 10 is configured and disposed to provide a speaker system that is selectively positionable about a belly of a user so as to allow music and/or spoken word broadcasts and recordings to be delivered to the womb. As such, the system 10 of the present invention generally includes a pouch section 12 for housing one or more speakers 14, 16 and a fastener section 18 for maintaining the positioning of the pouch 12 about the belly area of the user. It is understood that the phrase “about the belly” refers to the positioning of the pouch 12 anywhere proximate the belly including above, below or directly on the belly of the user. Preferably, however, the pouch 12 is positioned below the belly in accordance with a preferred embodiment of the present invention.

It is understood that the various components of the system 10 of the present invention may take on any number of configurations and arrangements. Described herein with reference to the various figures is a preferred embodiment of the present invention, whereas one of ordinary skill in the art will understand that various modifications to the system may be made within the scope and spirit of the preferred embodiment.

The pouch 12 of the present invention includes a front panel 20 and a rear panel 22 wherein the rear panel 22 is configured to comfortably engage the belly of the user and the front panel 20 is disposed to face outwardly therefrom. The front panel 20 and rear panel 22 are preferably made of a wearable fabric, polymer or blended material as are commonly known in the clothing and fabric arts.

In the present invention the front panel 20 and rear panel 22 are integrally formed or otherwise affixed to each other along a bottom portion and at opposing side portions therof. As such, an opening 24 is defined in a top portion of the pouch 12. The opening 24 is selectively openable and closable by any suitable fastening mechanism 26 such as the zipper mechanism shown in the present embodiment. Alternative fastening mechanisms may alternatively be employed as are commonly known in the art, including but not limited to button fasteners, hook and loop fasteners (e.g. Velcro), clips, or any other such mechanism.

Further defined within the pouch 12 of the present invention is a first speaker compartment 28 and a second speaker compartment 30. In the present embodiment the speaker compartments 28, 30 are defined by an inner stitching or stapling section, spaced from the side edges of the pouch 12. As such, one or more inner stitching or stapling sections cooperate to partially affix the front panel 20 and rear panel 22 so as to prevent movement of the speakers 14, 16 from their corresponding compartments 28, 30. It is understood that a traditional pocket may be utilize to form the speaker compartments or any other such configuration sufficient to maintain the speakers 14, 16 therein. However, in the present embodiment, the side compartments 28, 30 of the pouch 12 provide a port 32, 34 through which audio cable lines 36 are able to extend from an adjacent central compartment 38.

Turning now to the central compartment 38 of the pouch 12, such compartment 38 is disposed to receive a music player 40, preferably an MP3 player such as an iPod (R) or any other such suitable device through the opening 24. The compartment 38, of course, may alternatively receive a cassette player, radio receiver or any other suitable handheld portable music device.

In accordance with the present invention, the audio cable line 36 will extend from each speaker 14, 16 to a common speaker jack 42 that is configured to be connected to the music player 40. As such, the audio line 36 for each speaker 14, 16 will extend through the corresponding port 32, 24 in the compartment 28, 30, respectively, to the music player 40 in the central compartment 38. Preferably, the speakers 14, 16, music player 40, and audio line 36 provide for stereo sound as is common in the art.

As shown, the audio cable line 36 may additionally include a splitter 44 wherein a first line of the splitter 44 provides a headphone jack 46 and a second line of the splitter 44 provides the audio cable line 36 for the speakers 14, 16. As such, the user is able to listen to the music from the music player 40 on headphones while the same music is being delivered to the belly of the user via the speakers 14, 16.

As shown in the figures, the pouch 12 may additionally include a padding layer 48 in order to provide added comfort to the belly of the user as well as additional protection to the speakers 14, 16 and music player 40. The padding 48 may be any suitable material in order to cooperate with the panels of the pouch as are commonly known in the art.

An adjustable ribbon 50 is connected at opposing sides of the pouch 12 such that a first end of the ribbon is secured to a first side of the pouch 12 and a second end of the ribbon 50 is adjustably connectable to the second side of the pouch 12. It is understood that any suitable strap, ribbon or belt material may be used in combination with any suitable adjusting mechanism, a variety of which are commonly known in the art.

However, it is preferable that a ribbon material be used for purposes of comfort to the user. As such, the preferable adjusting mechanism for use with the ribbon 50 is that shown in the figures wherein the ribbon 50 is curled around a loop fastener 52 and may include a belt loop adjuster to adjust the length of the ribbon 50 for fitting around the body of the user/wearer. Additionally, it is preferable that at least one end of the ribbon be selectively fastenable and/or attachable to the pouch such as via a buckle or hook or any other suitable fastening mechanism as is commonly known in the art.

Whereas the above description is illustrative of the various components and functions of the present invention, discussion now turns to the method for using the present invention.

A method for providing music to a pregnant belly is provided wherein the pouch 12 is positioned on the pregnant belly such that the first speaker 14 and second speaker 16 are disposed to deliver music thereto. The ribbon 50 fastening system 52 are disposed to extend around the user and adjustably maintain the pouch 12 about the belly of the user. The user may access the inner compartments 28, 30, 38 of the pouch 12 through the opening 24 in the top portion of the pouch 12 which is accessible by a zipper or other such selective fastening mechanism 26. The pouch 12 is divided into three compartments 28, 30, 36 wherein the two opposing side compartments 28, 30 maintain corresponding speakers 14, 16 therein. The central compartment 38 provides an audio speaker line 36 for connecting the music player 40 to the speakers 14,1 6. The user may then dispose the music player 40 within the central compartment 38 and connect the audio speaker line 36 thereto so as to provide music to the pregnant belly. Additionally, the audio speaker line 36 may provide a splitter 44 such that the user may also selectively connect headphones thereto, allowing the user to simultaneously listen to the music from the music player 40 through the headphones while delivering music to the user's pregnant belly via the speakers 14, 16.

The foregoing description is presented to enable one of ordinary skill in the art to make and use the invention and is provided in the context of a patent application and its requirements. Various modifications to the systems, methods and the general principles and features of the system and methods described herein will be readily apparent to those of skill in the art. Thus, the present invention is not to be limited to the embodiments of described above and illustrated in the drawing figures, but is to be accorded the widest scope consistent with the spirit and scope of the appended claims.

What is claimed is:

1. A belly pouch speaker system for delivering music to a belly of a wearer, said system comprising:
a) a pouch positioned about the belly of the wearer, said pouch containing at least one speaker compartment therein;
b) at least one speaker, positioned within said at least one speaker compartment, said at least one speaker being selectively coupled to a music player;
c) an adjustable ribbon having a first end securable to a first side of said pouch and a second end securable to a second side of said pouch wherein said adjustable ribbon is positionable about the wearer so as to maintain the position of the pouch about the belly of the wearer.

2. The belly pouch speaker system from claim 1 wherein said ribbon has an adjustable length.

3. The belly pouch speaker system from claim 1 wherein said ribbon is selectively fastened to said pouch at at least one of said first and second ends of said ribbon.

4. The belly pouch speaker system from claim 1 wherein said pouch comprises a second speaker compartment therein.

5. The belly pouch speaker system from claim 4 wherein said pouch comprises a second speaker in said second speaker compartment.

6. The belly pouch speaker system from claim 5 wherein said pouch further comprises a space for receiving said music player therein.

7. The belly pouch speaker system from claim 6 wherein said pouch further includes a padding on a surface of said pouch that is positioned about the belly of the wearer.

8. A method for providing music to a pregnant belly comprising the steps of:
a) positioning a pouch about said pregnant belly, said pouch having a music player and at least one speaker positioned therein;
b) adjusting a ribbon around a body of said wearer to maintain the positioning of said pouch about said pregnant belly;
c) providing music to said pregnant belly via said at least one speaker;
d) providing music to the user via a set of headphones coupled to said music player.

9. A system for simultaneously providing music to two locations on a wearer's body, comprising:
a) a pouch having at least one speaker compartment and a music player compartment;
b) a first speaker positioned within said at least one speaker compartment;
c) an audio speaker line coupled to said music player and simultaneously coupled to said first speaker and to a set of headphones wherein said pouch is positionable about a first location on the wearer's body and said headphones are wearable about a second location on the wearer's body.

10. The system from claim 9 wherein said first location of said wearer's body is a pregnant belly and said second location is said wearer's ears.
